(19) United States
(12) Patent Application Publication
(10) Pub. No.: US 2020/0410189 A1
(43) Pub. Date: Dec. 31, 2020

(54) BIOMETRIC FINGERPRINT PHOTOACOUSTIC TOMOGRAPHIC IMAGING

(71) Applicant: QUALCOMM Incorporated, San Diego, CA (US)

(72) Inventors: Jack Conway Kitchens, Buffalo, NY (US); John Keith Schneider, Williamsville, NY (US); Evan Michael Breloff, Kenmore, NY (US); Emily Kathryn Brooks, Buffalo, NY (US); Stephen Michael Gojevic, Lockport, NY (US); James Anthony Miranto, Kenmore, NY (US); Alexei Stoianov, Toronto, CA (US); Fitzgerald John Archibald, Toronto, CA (US)

(21) Appl. No.: 16/454,386

(22) Filed: Jun. 27, 2019

(51) Int. Cl. G06K 9/00; G06F 21/32

(52) U.S. Cl. CPC G06K 9/0002; G01N 29/2437; G06F 21/32

(57) ABSTRACT

The described techniques support a sensing scheme for electromagnetic excitation in ultrasonic imaging sensors. A biological tissue may be sensed and imaged using an electromagnetic excitation process to generate ultrasonic waves, such as, within the tissue. A component of a device may generate one or more pulses of electromagnetic waves, which may encounter and enter the biological tissue. The electromagnetic waves may excite the biological tissue and generate ultrasonic waves via expansion and contraction of the tissue upon heating. The ultrasonic waves may propagate within the biological tissue and may be sensed by an ultrasonic receiver array. The ultrasonic waves may be converted to pixel image data of a biometric image and may be used for biometric authentication. This process may be repeated to reconstruct an image of the finger at multiple plane slices of the finger.

### BACKGROUND

Some devices may support biometric identification methods, for example, fingerprint identification. These methods may relate to capturing an image of an individual's finger and to whether a pattern of ridges and valleys in the fingerprint image match a pattern. Some challenges, among others, of these methods include fingerprint identification when ridges or valleys of the individual's finger are worn, unclear, or damaged. Additionally, these methods may be susceptible to an individual attempting, for example, to deceptively defeat the biometric identification and verification.

### SUMMARY

Some examples of a device, such as a smartphone, may support biometric authentication schemes, for example, for user access. In the context of a fingerprint imager, an ultrasonic wave may propagate through a surface of the smartphone on which a person's finger may be placed to obtain a fingerprint image. After passing through the surface, some portions of the wave may encounter skin that is in contact with the surface (e.g., fingerprint ridges), while other portions of the ultrasonic wave encounter air (e.g., valleys between adjacent ridges of a fingerprint) and may be reflected with different intensities back toward the ultrasonic fingerprint imager. The reflected signals associated with the finger may be processed and converted to a digital value representing the signal strength of the reflected signal. When multiple reflected signals are collected over a distributed area, the digital values of such signals may be used to produce a representation of the signal strength over the distributed area (e.g., by converting the digital values to an image), thereby producing an image of the fingerprint.

Examples of imaging sensors, such as ultrasonic imaging sensors, are deployed in devices, and more specifically in various applications, such as fingerprint recognition. In fingerprint recognition applications, an ultrasonic imaging sensor having an array of transducer components may determine ridges and valleys of a fingerprint by capturing signals (for example in response to a time-varying excitation voltage) and determining the differences in signal amplitudes between the ridges and valleys. In some examples, an acoustic ensonification process used to generate ultrasonic waves (also referred to herein as ultrasonic signals) for an ultrasonic imaging sensor may be high in power consumption. New techniques for creating ultrasonic waves may be desired.

A finger may be sensed and imaged using an electromagnetic excitation process to generate ultrasonic waves within the finger. A light emitting source of a device may generate one or more pulses of electromagnetic waves (e.g., light waves, radio waves, infrared waves, ultraviolet waves, etc.) with one or more characteristics, which may enter the finger. The photons of the electromagnetic waves may excite (e.g., via photothermal interaction) biological tissue within the finger and generate ultrasonic waves. The ultrasonic waves may propagate within the biological tissue and may be sensed by an ultrasonic receiver array of the device. The ultrasonic waves may be converted to pixel image data of an image (e.g., fingerprint or blood vessel) and may be output by the device and used for biometric authentication. This process may be repeated to reconstruct an image of the finger at multiple plane slices of the finger (e.g., via backscatter reconstruction or directionally receiving signals from the multiple plane slices).

A method of biometric identification at a device is described. The method may include generating one or more pulses of electromagnetic radiation waves having one or more characteristics, emitting the one or more pulses of electromagnetic radiation waves to generate one or more ultrasonic signals associated with one or more biological tissues of a finger, sensing the one or more generated ultrasonic signals at a set of plane slices of the one or more biological tissues using an ultrasonic receiver array based on emitting the one or more pulses of electromagnetic radiation waves, performing fingerprint information reconstruction using the one or more ultrasonic signals to generate fingerprint information at one or more plane slices of the set of plane slices of the one or more biological tissues, generating a fingerprint image including ridges and valleys associated with the finger based on performing the fingerprint information reconstruction, and outputting a representation of the fingerprint image.

An apparatus for biometric identification at a device is described. The apparatus may include a processor, memory coupled with the processor, and instructions stored in the memory. The instructions may be executable by the processor to cause the apparatus to generate one or more pulses of electromagnetic radiation waves having one or more characteristics, emit the one or more pulses of electromagnetic radiation waves to generate one or more ultrasonic signals associated with one or more biological tissues of a finger, sense the one or more generated ultrasonic signals at a set of plane slices of the one or more biological tissues using an ultrasonic receiver array based on emitting the one or more pulses of electromagnetic radiation waves, perform fingerprint information reconstruction using the one or more ultrasonic signals to generate fingerprint information at one or more plane slices of the set of plane slices of the one or more biological tissues, generate a fingerprint image including ridges and valleys associated with the finger based on performing the fingerprint information reconstruction, and output a representation of the fingerprint image.

Another apparatus for biometric identification at a device is described. The apparatus may include means for generating one or more pulses of electromagnetic radiation waves having one or more characteristics, emitting the one or more pulses of electromagnetic radiation waves to generate one or more ultrasonic signals associated with one or more biological tissues of a finger, sensing the one or more generated ultrasonic signals at a set of plane slices of the one or more biological tissues using an ultrasonic receiver array based on emitting the one or more pulses of electromagnetic radiation waves, performing fingerprint information reconstruction using the one or more ultrasonic signals to generate fingerprint information at one or more plane slices of the set of plane slices of the one or more biological tissues, generating a fingerprint image including ridges and valleys associated with the finger based on performing the fingerprint information reconstruction, and outputting a representation of the fingerprint image.

A non-transitory computer-readable medium storing code for biometric identification at a device is described. The code may include instructions executable by a processor to generate one or more pulses of electromagnetic radiation waves having one or more characteristics, emit the one or more pulses of electromagnetic radiation waves to generate one or more ultrasonic signals associated with one or more biological tissues of a finger, sense the one or more generated ultrasonic signals at a set of plane slices of the one or more biological tissues using an ultrasonic receiver array based on emitting the one or more pulses of electromagnetic radiation waves, perform fingerprint information reconstruction using the one or more ultrasonic signals to generate fingerprint information at one or more plane slices of the set of plane slices of the one or more biological tissues, generate a fingerprint image including ridges and valleys associated with the finger based on performing the fingerprint information reconstruction, and output a representation of the fingerprint image.

In some examples of the method, apparatuses, and non-transitory computer-readable medium described herein, generating the one or more pulses of electromagnetic radiation waves may include operations, features, means, or instructions for generating, via a light emitting source of the device, the one or more pulses of electromagnetic radiation waves, where the light emitting source includes a light emitting diode (LED) or an organic light emitting diode (OLED) display interface.

In some examples of the method, apparatuses, and non-transitory computer-readable medium described herein, performing the fingerprint information reconstruction may include operations, features, means, or instructions for performing a backscatter reconstruction at different plane slices of the set of plane slices of the one or more biological tissues to generate a backscattered reconstructed fingerprint image of the different plane slices of the set of plane slices, where generating the fingerprint image includes applying a point spread function to the backscattered reconstructed fingerprint image to generate the fingerprint image.

In some examples of the method, apparatuses, and non-transitory computer-readable medium described herein, sensing the one or more generated ultrasonic waves may include operations, features, means, or instructions for sensing, via a piezoelectric micromachined ultrasonic transducer (PMUT) of the device, the one or more generated ultrasonic waves, where the fingerprint image includes a tomographic fingerprint image or a tomographic vascular image based on sensing the one or more generated ultrasonic waves over the set of plane slices of the one or more biological tissues.

In some examples of the method, apparatuses, and non-transitory computer-readable medium described herein, the PMUT of the device may include operations, features, means, or instructions for controlling a directionality of the array of pixel elements of the PMUT based on a propagation direction of the one or more pulses of electromagnetic radiation waves, and collecting phases and amplitudes of the one or more generated ultrasonic waves at different plane slices of the set of plane slices of the one or more biological tissues based on the controlling, where generating the fingerprint image may be further based on combining one or more generated ultrasonic waves at same plane slices of the set of plane slices based on the phases and the amplitudes of the one or more generated ultrasonic waves.

In some examples of the method, apparatuses, and non-transitory computer-readable medium described herein, collecting the phases and the amplitudes of the one or more generated ultrasonic waves at different plane slices of the set of plane slices of the one or more biological tissues may include operations, features, means, or instructions for activating one or more of pixel rows or pixel columns of the array of pixel elements based on a pattern.

In some examples of the method, apparatuses, and non-transitory computer-readable medium described herein, the PMUT of the device may include operations, features, means, or instructions for converting the one or more generated ultrasonic waves to one or more pixels based on one or more pixel elements of the array of pixel elements, where generating the fingerprint image may be further based on the converting.

Some examples of the method, apparatuses, and non-transitory computer-readable medium described herein may further include operations, features, means, or instructions for synchronizing an activation time of a light emitting source of the device and an exposure time of one or more of a camera of the device to sense the one or more pulses of electromagnetic radiation waves or the ultrasonic receiver array to sense the one or more generated ultrasonic waves at the set of plane slices of the one or more biological tissues, where generating the fingerprint image includes performing, based on the synchronizing, range gated imaging at the one or more plane slices of the set of plane slices of the one or more biological tissues to generate a multi-dimensional fingerprint image.

In some examples of the method, apparatuses, and non-transitory computer-readable medium described herein, generating the one or more pulses of electromagnetic radiation waves may include operations, features, means, or instructions for selecting one or more characteristics of the one or more pulses of electromagnetic radiation waves based on a target plane slice of the set of plane slices associated with the one or more biological tissues of the finger, where emitting the one or more pulses of electromagnetic radiation waves includes emitting the one or more pulses of electromagnetic radiation waves having the one or more characteristics based on the selecting, the one or more characteristics comprising one or more of the intensity of the one or more pulses of electromagnetic radiation waves, the propagation direction of the one or more pulses of electromagnetic radiation waves, or the wavelength of the one or more pulses of electromagnetic radiation waves.

In some examples of the method, apparatuses, and non-transitory computer-readable medium described herein, the wavelength may be within a radio spectrum of an electromagnetic spectrum, a microwave spectrum of the electromagnetic spectrum, a near-infrared spectrum of the electromagnetic spectrum, an infrared spectrum of the electromagnetic spectrum, a visible spectrum of the electromagnetic spectrum, or an ultraviolet spectrum of the electromagnetic spectrum.

Some examples of the method, apparatuses, and non-transitory computer-readable medium described herein may further include operations, features, means, or instructions for determining a profile of the one or more biological tissues of the finger based on sensing the one or more generated ultrasonic waves at the set of plane slices of the one or more biological tissues using the ultrasonic receiver array, determining a liveliness level of the one or more biological tissues of the finger based on the profile, where outputting the representation of the fingerprint image includes outputting the liveliness level associated with the one or more biological tissues of the finger.

In some examples of the method, apparatuses, and non-transitory computer-readable medium described herein, the profile includes a shape of a biological tissue of the one or more biological tissues of the finger or a size of the biological tissue of the one or more biological tissues of the finger, or both.

In some examples of the method, apparatuses, and non-transitory computer-readable medium described herein, outputting the representation of the fingerprint image may include operations, features, means, or instructions for outputting, via an OLED display interface of the device, the representation of the fingerprint image.

### BRIEF DESCRIPTION OF THE DRAWINGS

FIG. 1 illustrates an example of a system that supports biometric fingerprint photoacoustic tomographic imaging in accordance with aspects of the present disclosure.

FIG. 2 illustrates an example of a sensing scheme that supports biometric fingerprint photoacoustic tomographic imaging in accordance with aspects of the present disclosure.

FIGS. 3A through 3C illustrate examples of sensing modes that support biometric fingerprint photoacoustic tomographic imaging in accordance with aspects of the present disclosure.

FIGS. 4A through 4D illustrate examples of beamforming techniques that support biometric fingerprint photoacoustic tomographic imaging in accordance with aspects of the present disclosure.

FIG. 5 illustrates an example of a beamforming processing scheme that supports biometric fingerprint photoacoustic tomographic imaging in accordance with aspects of the present disclosure.

FIG. 6 shows a block diagram of a device that supports biometric fingerprint photoacoustic tomographic imaging in accordance with aspects of the present disclosure.

FIGS. 7 through 9 show flowcharts illustrating methods that support biometric fingerprint photoacoustic tomographic imaging in accordance with aspects of the present disclosure.

### DETAILED DESCRIPTION

Authentication data (e.g., such as usernames, passwords, biometric traits) is being increasingly used to control access to resources (e.g., such as computer and email accounts, mobile device access) and to prevent unauthorized access to important information or data stored in such accounts or devices. Biometric authentication techniques may provide for robust security due to, for example, the inherent universality, uniqueness, and permanence of certain biometric traits. For example, a device (e.g., computer, mobile device) may utilize biometric authentication techniques for user access. In the context of an ultrasonic fingerprint imager, as an example, an ultrasonic wave may travel through a surface on which a person's finger may be placed to obtain a fingerprint image. After passing through the surface, some portions of the ultrasonic wave may encounter skin that is in contact with the surface (e.g., fingerprint ridges), while other portions of the ultrasonic wave may encounter air (e.g., valleys between adjacent ridges of a fingerprint) and may be reflected with different intensities (e.g., back toward) the ultrasonic sensor.

The reflected signals associated with the finger may be processed and converted to a digital value representing the signal strength of the reflected signal. When multiple reflected signals are collected (e.g., over a distributed area), the digital values of such signals may be used to produce a representation, such as a graphical representation, of the signal strength over the distributed area (e.g., by converting the digital values to an image), thereby producing an image of the fingerprint. Thus, an ultrasonic sensor system may be used as a fingerprint sensor or other type of biometric sensor. In some cases, transmitting ultrasonic waves into a finger (e.g., or other biological tissue) may consume a high amount of power.

Accordingly, a biological tissue (e.g., finger, eye, etc.) may be sensed and imaged using an electromagnetic excitation process to generate ultrasonic waves. A radiation component (also referred to as a light emitting source) of a device may generate one or more pulses of electromagnetic waves (e.g., light waves, radio waves, infrared waves, ultraviolet waves, etc.), which may encounter and enter the biological tissue. The photons of the electromagnetic waves may excite (e.g., via photothermal interaction) the biological tissue and generate ultrasonic waves. The ultrasonic waves may propagate within the biological tissue and may be sensed by an ultrasonic sensor (e.g., an ultrasonic receiver array). The ultrasonic waves may be converted to pixel image data (e.g., a fingerprint image, blood vessel image, retinal scan, etc.) and may be used for biometric authentication. This process may be repeated to reconstruct an image of the biological tissue at multiple plane slices of the tissue (e.g., via backscatter reconstruction or directionally receiving signals from the multiple plane slices).

The electromagnetic waves may include radio frequency energy, green light, visible light, microwaves, near-infrared waves, infrared waves, or ultraviolet waves created by the one or more electromagnetic radiation components (e.g., a source). In some cases, the source of electromagnetic waves may be a display, such as a device display. Additionally or alternatively, the source of electromagnetic waves may be separate from a device display. In some examples, the wavelength of the electromagnetic waves may determine a depth of penetration into the biological tissue. Accordingly, the wavelength of the electromagnetic waves may be selected based on a target depth of penetration into biological tissue or a plane slice of the biological tissue being imaged (e.g., based on the portions of the biological tissue that are being imaged). Other electromagnetic wave characteristics may be selected based on a target depth or plane slice being imaged.

Aspects of the disclosure are initially described in the context of a system for ultrasonic imaging sensors. An example sensing scheme, example sensing modes, example beamforming techniques, and an example beamforming processing scheme are then described. Aspects of the disclosure are further illustrated by and described with reference to apparatus diagrams, system diagrams, and flowcharts that relate to ultrasonic fingerprint scanning by means of photoacoustic excitation.

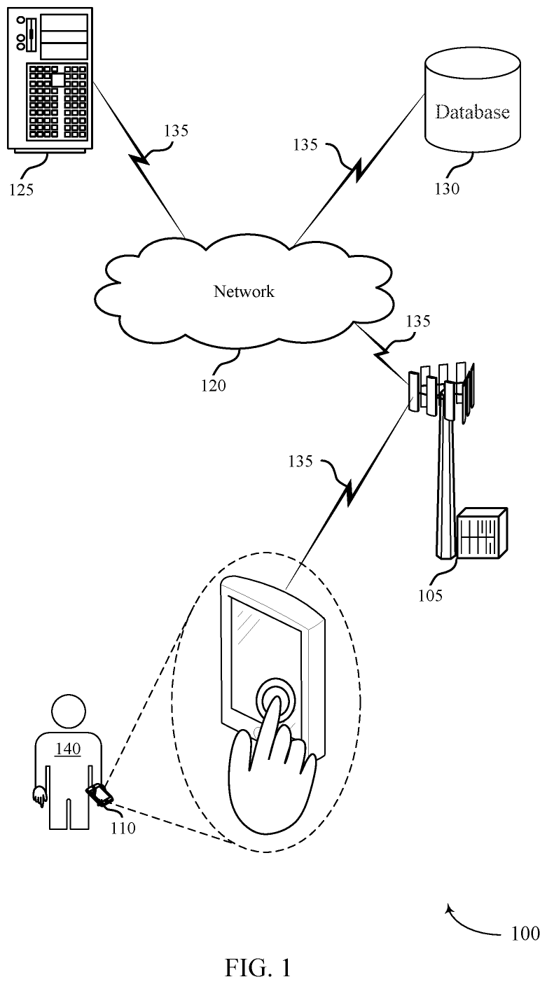

FIG. 1 illustrates an example of a system 100 that supports biometric fingerprint photoacoustic tomographic imaging in accordance with aspects of the present disclosure. In some examples, the system 100 may be a wireless communications system that may be a multiple-access wireless communications system, for example, such as a fourth generation (4G) systems such as Long Term Evolution (LTE) systems, LTE-Advanced (LTE-A) systems, or LTE-A Pro systems, and fifth generation (5G) systems which may be referred to as New Radio (NR) systems, as well as wireless local area networks (WLAN), such as Wi-Fi (i.e., Institute of Electrical and Electronics Engineers (IEEE) 802.11) and Bluetooth-related technology. The system 100 may include a base station 105, a device 110, a server 125, and a database 130. In some examples, the system 100 may also include a user 140, and the device 110 may employ sensing techniques with the user 140. For example, the device 110 may employ biometric sensing techniques (e.g., ultrasonic imaging processing) for the user 140 to sense and image a fingerprint or other biometric identification of the user 140. The aspects of the system 100 are solely for exemplary purposes, and are not intended to be limiting in terms of the applicability of the described techniques. That is, the techniques described herein may be implemented in, or applicable to, other examples of biometric scanning, without departing from the scope of the present disclosure. For example, the described ultrasonic imaging sensor and associated biometric sensing techniques may be applied for scanning of other biometric traits (e.g., such as an eyeball or retina, a face, etc.).

The device 110 may be referred to as a mobile device, a wireless device, a remote device, a handheld device, a subscriber device, an authentication device, a biometric sensing device, a scanning device, or some other suitable terminology. A device 110 may also be a personal electronic device such as a cellular phone, a personal digital assistant (PDA), a tablet computer, a laptop computer, a personal computer, a display device (e.g., any device with a display or screen), etc. In some examples, the device 110 may also be referred to as an Internet of Things (IoT) device, an Internet of Everything (IoE) device, a machine type communication (MTC) device, a peer-to-peer (P2P) device, or the like, which may be implemented in various articles such as appliances, vehicles, meters, or the like. Further examples of device 110 that may implement one or more aspects of ultrasonic biometric sensors and associated techniques may include Bluetooth devices, personal data assistants (PDAs), wireless electronic mail receivers, hand-held or portable computers, netbooks, notebooks, printers, copiers, scanners, cash machines, facsimile devices, GPS receivers/navigators, cameras, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, and projectors, and the like.

Any of such device 110 may include a sensor, for example, an ultrasonic imaging sensor (also referred to herein as an ultrasonic biometric sensor, or simply an ultrasonic sensor) configurable (or configured with) piezoelectric micromachined ultrasonic transducers (PMUTs), capacitive micromachined ultrasonic transducers (CMUTs), or the like. The ultrasonic imaging sensor may be configured to determine ridges and valleys of a fingerprint or a blood vessel geometry of the user 140. Additionally or alternatively, the ultrasonic imaging sensor (e.g., using output from the sensor) may be configured to determine a biometric liveness level, examine the health of blood vessels (e.g., arterial pulse wave velocity, blood pressure, etc.), or determine other blood vessel characteristics. For example, the ultrasonic imaging sensor may determine a liveness level of biological tissues of a finger or other biological tissues of the user 140 based on a determined shape (e.g., in an image) of the biological tissues.

In some examples, a PMUT of the device 110 may be a 3-port PMUT. In some examples, the PMUT may include a layer of piezo-sensitive material (e.g., such as a continuous copolymer) between an electrode array and a common electrode (e.g., a reference electrode). The PMUT operation may be based on a flexural motion (e.g., bending) of a thin membrane coupled with a thin piezoelectric film (e.g., piezo-sensitive material), such as polyvinylidene fluoride (PVDF), where a bending mode output of the piezoelectric film may be many times more than that of a compression mode. PMUT may offer advantages for sensor arrays such as increased bandwidth, flexible geometries, reduced voltage constraints, and multiple resonant frequencies. PMUT sensors may operate in a broadband mode and may be used for imaging arrays.

A CMUT of the device 110 may be a transducer that is based on the movement of a pressure diaphragm that is one electrode of a capacitor. A CMUT may be constructed on a semiconductor (e.g., silicon) using micromachining techniques, or may be constructed using various ceramic materials. The CMUT may include a cavity formed in a substrate and a thin layer or membrane (e.g., metallized layer) suspended over the cavity that may serve as a measurement diaphragm. In some cases, the cavity may be filled with a dielectric oil or spacer to increase capacitance of the CMUT. The metallized layer may act as a top electrode of the capacitor and the substrate may act as a bottom electrode of the capacitor. If the CMUT is configured as a transmitter, an AC voltage may be applied across the electrodes and the membrane may vibrate to produce ultrasonic waves. If the CMUT is configured as a receiver, ultrasonic waves applied to the membrane of the CMUT may generate an alternating voltage signal as the capacitance of the CMUT varies due to vibrations in the top electrode. CMUT sensors may be constructed as two-dimensional (2D) arrays of transducers, where large numbers of CMUT elements may be included in a transducer array, providing larger bandwidth (e.g., compared to other transducer technologies). CMUT arrays may achieve a high frequency operation due to their smaller dimensions, where the frequency of operation may depend on a cell size (e.g., cavity size) and a stiffness of the top electrode membrane. Like PMUT sensors, CMUT sensors may operate in a broadband mode and may be used for imaging arrays.

The ultrasonic receiver or sensor array of the device 110 (e.g., PMUT or CMUT array) may include one or more electrodes that may each be associated (e.g., connected to) a transceiver circuit (e.g. a transmit circuit and a receive circuit), and each electrode in the sensor array may perform aspects of biometric sensing and imaging (e.g., to sense and image a fingerprint or blood vessel geometry). In some examples, the sensor of the device 110 may be attached to or mounted on a frame of the device 110 near or under a cover surface of the device's 110 display (e.g., an organic light emitting diode (OLED) display, plastic OLED (pOLED) display, etc.). Further, the device 110 may include electrical connections associated with the sensor.

For example, the device 110 may include an array of pixel circuits disposed on a substrate (e.g., which may be referred to as a backplane). In some examples, each pixel circuit may include one or more thin-film transistor components, electrical interconnect traces and, in some examples, one or more additional circuit components such as diodes, capacitors, and the like. Each pixel circuit may include a pixel input electrode (e.g., that electrically couples the piezoelectric or capacitive layer to the pixel circuit). A layer of piezo-sensitive material or capacitive material may provide for a thin layer, between the common electrode and the sensor array, with desirable material properties to isolate each pixel from neighboring pixels and enable effective ultrasonic signal sensing.

An ultrasonic signal (e.g., ultrasonic waves) may be generated within a finger or other biological tissue of the user 140 (e.g., using a photoacoustic excitation process), such that a generated signal may be measured by the sensor of the device 110. For example, a biological tissue (e.g., finger, eye, etc.) may be biometrically sensed and imaged using an electromagnetic (e.g., photoacoustic) excitation process that generates ultrasonic waves. A radiation component of the device 110 may generate one or more pulses of electromagnetic waves (e.g., light waves, radio waves, infrared waves, ultraviolet waves, etc.), which may encounter the biological tissue and enter the biological tissue. The photons of the electromagnetic waves may excite the biological tissue and generate ultrasonic waves. The ultrasonic waves may propagate within the biological tissue and may be sensed by an ultrasonic sensor (e.g., an ultrasonic receiver array of the device 110). The ultrasonic waves may be converted to pixel image data (e.g., a fingerprint image, retinal scan, etc.) and may be used for biometric authentication. This imaging process may, in some cases, be repeated at multiple plane slices within the biological tissue to form a tomographic image of the biological tissue.

Some portions of the ultrasonic wave may meet skin that is in contact with the surface (e.g., fingerprint ridges), while other portions of the ultrasonic wave encounter air (e.g., valleys between adjacent ridges of a fingerprint), and may be received with different intensities at the sensor. Similarly, different types of tissues (e.g., blood vessels) may generate ultrasonic waves with different intensities toward the sensor. Each pixel circuit may be configured to convert an electric charge generated in the piezoelectric or capacitive receiver layer (e.g., from the reflected ultrasonic signal) proximate to the pixel circuit into an electrical signal. For example, localized charges may be collected by the pixel input electrodes and passed on to the underlying pixel circuits. The charges may then be amplified by the pixel circuits and provided to the control electronics, which processes the output signals.

Ultrasonic signals associated with the fingerprint of the user 140 may thus be processed by the device 110 and converted to a digital value representing the signal strength of the received signal. When multiple ultrasonic signals are collected over a distributed area, the digital values of such signals may be used to produce a representation, such as a graphical representation of the signal strength over the distributed area (e.g., by converting the signals to pixels). For example, the device 110 may convert the digital values to an image (e.g., pixels forming an image), thereby producing an image of the finger of the user 140 (e.g., fingerprint, vascular image, etc.). In some examples, the device 110 may further compare the produced image to a stored image (e.g. stored in database 130) for authentication decisions.

For example, each pixel of a pixel array may be associated with a region (e.g., a local region) of the piezo-sensitive or capacitive layer, and may include or be associated with a peak detection diode and a readout transistor (e.g., these components may be formed on or in the backplane to form the pixel circuit). The region of piezoelectric or capacitive sensor material of each pixel may transduce received ultrasonic energy into electrical charges. The peak detection diode may register the maximum amount of charge sensed by the region of piezoelectric or capacitive sensor material. Each row of the pixel array may then be scanned (e.g., through a row select mechanism, a gate driver, or a shift register) and the readout transistor for each column may be triggered to allow the magnitude of the peak charge for each pixel to be read by additional circuitry (e.g., a multiplexer, an analog to digital converter, etc.). The pixel circuit may include one or more thin-film transistors to allow gating, addressing, and resetting of the pixel. Each pixel circuit may provide information about a small portion of the finger sensed by the sensor of the device 110. In some examples, the detection area of the sensor of the device 110 may be selected. For example, the detection area may range from about 5 mm×5 mm for a single finger to about 3 inches×3 inches for four fingers. Smaller and larger areas, including square, rectangular and non-rectangular geometries, may be used as appropriate biometric sensing and imaging.

The server 125 may be a computing system or an application that may be an intermediary node in the system 100 between the device 110 or the database 130. The server 125 may include any combination of a data server, a cloud server, a server associated with an authentication service provider, proxy server, mail server, web server, application server (e.g., authentication application server), database server, communications server, home server, mobile server, or any combination thereof. The server 125 may also transmit to the device 110 a variety of authentication information, such as biometric information, configuration information, control instructions, and other information, instructions, or commands relevant to performing a biometric sensing operation (e.g., to sense and image a fingerprint of the user 140).

The database 130 may store data that may include biometric information for an authentication environment, or commands relevant to reducing background signals for the device 110 when performing a biometric sensing operation (e.g., to sense and image a fingerprint of the user 140). The device 110 may retrieve the stored data from the database via the network 120 using communication links 135. In some examples, the database 130 may be a relational database (e.g., a relational database management system (RDBMS) or a Structured Query Language (SQL) database), a non-relational database, a network database, an object-oriented database, among others that stores the variety of biometric information, such as instructions or commands relevant to sensing biometric information.

The network 120 that may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using 3G, 4G, LTE, or NR systems (e.g., 5G for example), etc. Network 120 may include the Internet.

The base station 105 may wirelessly communicate with the device 110 via one or more base station antennas. Base station 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The device 110 described herein may be able to communicate with various types of base stations and network equipment including macro eNBs, small cell eNBs, gNBs, relay base stations, and the like.

The communication links 135 shown in the system 100 may include uplink transmissions from the device 110 to the base station 105, or the server 125, and/or downlink transmissions, from the base station 105 or the server 125 to the device 110. The downlink transmissions may also be called forward link transmissions while the uplink transmissions may also be called reverse link transmissions. The communication links 135 may transmit bidirectional communications and/or unidirectional communications. The communication links 135 may include one or more connections, including but not limited to, 345 MHz, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to system 100.

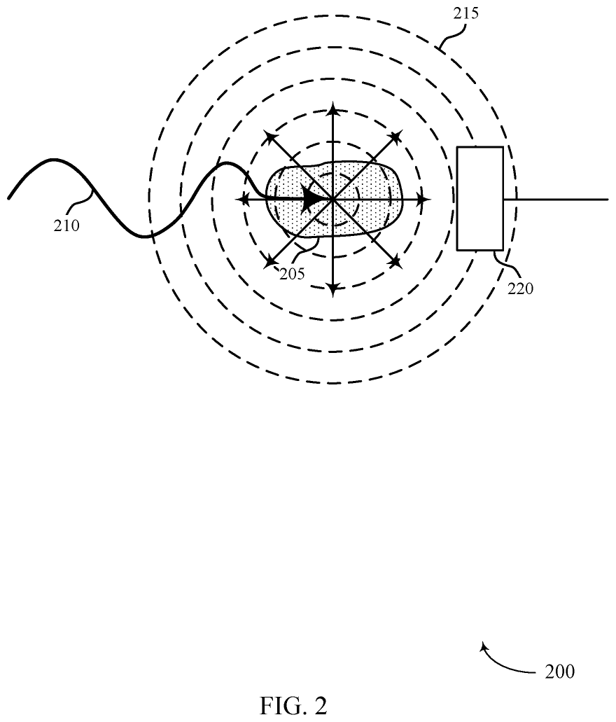

FIG. 2 illustrates an example of an excitation scheme 200 that supports biometric fingerprint photoacoustic tomographic imaging in accordance with aspects of the present disclosure. In some examples, excitation scheme 200 may implement aspects of system 100 and may be implemented by a device 110 described with reference to FIG. 1 (e.g., or by another device). A sensor on a device 110, such as an ultrasonic imaging sensor having one or more transducer components (e.g., PMUTs, CMUTs, etc.), may determine ridges and valleys of a fingerprint or blood vessel geometry for biometric sensing purposes. In some examples, the sensor configurable (or configured) with one or more electromagnetic radiation components (e.g., light emitting diodes (LEDs), radio wave antennas, etc.) may excite a biological tissue to generate one or more ultrasonic waves that may be sensed at the sensor (e.g., which may include a pixel array).

For example, a biological tissue 205 (e.g., finger, eye, etc.) may be sensed and imaged using a photoacoustic excitation process. One or more electromagnetic radiation components of a sensing device (e.g., device 110) may generate one or more time-varying (e.g., pulsed) electromagnetic waves 210 (e.g., light waves, radio waves, infrared waves, ultraviolet waves, etc.) having one or more characteristics. Electromagnetic waves 210 may encounter biological tissue 205 and may (e.g., partially) enter biological tissue 205 and excite biological tissue 205. For example, one or more photons of electromagnetic waves 210 may interact with biological tissue 205 to generate ultrasonic waves 215 (e.g., generate acoustic energy). In some examples, a region of biological tissue 205 may absorb one or more photons at different times, and the one or more photons may be converted into heat energy within the region of biological tissue 205. The region may change (e.g., expand, contract) due to temperature change from the heat energy when absorbing photons (e.g., thermo-elastic expansion) or from the lack of heat energy when not absorbing photons. The change may result in pressure changes that may be transmitted as ultrasonic waves 215.

In some cases, the pressure changes may propagate within biological tissue 205 and resulting ultrasonic waves 215 may be sensed by a sensor 220 (e.g., an ultrasonic receiver array, such as a PMUT array, CMUT array, etc.) coupled to biological tissue 205, and the ultrasonic waves may be converted to pixel image data. In some cases, electromagnetic waves 210 may be sensed by a sensor 220 (e.g., a camera, etc.) coupled to biological tissue 205, and the electromagnetic waves may be converted to pixel image data. In some cases, sensor 220 may image a number of plane slices through biological tissue 205 to generate a tomographic representation (e.g., image) of a fingerprint. For example, the device may be configured to generate (e.g., using targeted electromagnetic waves 210) and sense (e.g., via sensor 220) ultrasonic waves 215 generated across one or more planes associated with biological tissue 205. The sensed ultrasonic waves 215 (e.g., or electromagnetic waves 210) may be combined over different planes (e.g., in the same or different directions) to generate a tomographic image. In some cases, the image generated may include a size or a shape of biological tissue 205, which may be used to identify health concerns, determine liveness, or biometrically identify a user.

The device 110 may range gate the image data and repeat the imaging process multiple times over multiple plane slices of biological tissue 205 to build a three-dimensional (3D) model of biological tissue 205 (e.g., fingerprint, blood vessel geometry). In some cases, range gating the image data may include synchronizing an emission or activation time of the electromagnetic waves 210 with an exposure time of sensor 220 (e.g., camera or ultrasonic receiver array). Additionally or alternatively, the device 110 may perform information reconstruction using sensed ultrasonic waves 215 or electromagnetic waves 210 to generate biometric information (e.g., a fingerprint or blood vessel image) at the plane slices of biological tissue 205. In some cases, the device 110 may strobe rows or columns (e.g., one, two, three, etc. at a time) of electromagnetic waves 210 onto biological tissue 205 to avoid congestion at sensor 220. For example, sensor 220 may be congested if a sufficient number of elements in sensor 220 are active, which may cause signal degradation to occur due to receiver saturation.

In some cases, electromagnetic waves 210 may include radio frequency energy, green light, visible light, microwaves, near-infrared waves, infrared waves, or ultraviolet waves created by the one or more electromagnetic radiation components (e.g., a source). In some cases, the source of electromagnetic waves 210 may be a display, such as an OLED display (e.g., on a device 110) or another type of display. Additionally or alternatively, the source of electromagnetic waves 210 may be separate from a display of a device 110. In some cases, the source of electromagnetic waves 210 may be a radio wave antenna. In some examples, the wavelength of electromagnetic waves 210 may determine a depth of penetration into biological tissue 205 (e.g., because of tradeoffs between an extinction or absorption coefficient of a wavelength and a corresponding depth of penetration). For example, a green light wave may cause higher levels of excitation in biological tissue 205 and may have a shorter penetration depth, while an infrared wave may cause lower excitation levels and may have a larger penetration depth.

Accordingly, the wavelength of electromagnetic waves 210 may be selected, at least partially, based on a target depth of penetration into biological tissue 205 or based on target planes to be imaged (e.g., based on the portions of biological tissue 205 that are being imaged). In some cases, the device 110 may select one or more characteristics of electromagnetic waves 210 based on one or more target plane slices of biological tissue 205 to be imaged. For example, the one or more characteristics may include a wavelength, a propagation direction, an intensity, a pulse length, a pulse periodicity, or a pulse time of electromagnetic waves 210.

In some cases, different materials or biological tissues (e.g., one or more parts of biological tissue 205, or other biological tissues) may respond differently to different wavelengths of electromagnetic waves 210. For example, a wavelength that penetrates biological tissue 205 may not always interact with biological tissue 205 to produce ultrasonic waves 215. As such, the device 110 may be configured to select electromagnetic waves that may both produce the needed penetration into biological tissue 205 and interact with one or more selected portions of biological tissue 205. In one example, green light may react more strongly with hemoglobin within biological tissue 205, green light may penetrate sufficiently deep into biological tissue 205 (e.g., 1 to 1.5 millimeters (mm)) to reach hemoglobin, and green light may give a sufficiently strong signal to be sensed ultrasonically. Accordingly, the device 110 may be configured to biometrically image hemoglobin (e.g., image blood vessels by exciting hemoglobin) using green wavelengths or a specific green wavelength, as merely one example.

In some examples, a display (e.g., OLED smartphone display) may be used as the source for electromagnetic waves 210, where the display may excite biological tissue 205 with both red wavelengths (e.g., to excite deeper features of biological tissue 205) and blue or green wavelengths (e.g., to excite near-surface features of biological tissue 205).

In one example, excitation scheme 200 may be used to generate a biometric image of a finger (e.g., a finger may represent biological tissue 205), such as a fingerprint or a blood vessel image. Accordingly, one or more electromagnetic waves 210 may be generated by a sensing device (e.g., device 110) and may interact with the finger. As discussed above, electromagnetic waves 210 may generate one or more ultrasonic waves 215 within the finger (e.g., within blood vessels) that may propagate through the finger. Ultrasonic waves 215 may excite hemoglobin in capillaries and blood vessels in the finger and may produce a fingerprint or blood vessel image at a sensor 220, as discussed with reference to FIG. 1. For example, ridges of a fingerprint may pass ultrasonic waves 215 and valleys of the fingerprint may not pass ultrasonic waves 215 (e.g., or may pass ultrasonic waves with a lower power), resulting in a fingerprint image that may be sensed or generated at sensor 220. In some cases, the image generated may include a size or a shape of a fingerprint or a blood vessel (e.g., to use to biometrically identify a user). The sensed image may be output by the device 110, and may include a liveness level measurement, in some examples. This sensing process may be carried out without an acoustic ensonification process because the ultrasonic pulse may be generated within the finger (e.g., instead of creating external acoustic or ultrasonic waves).

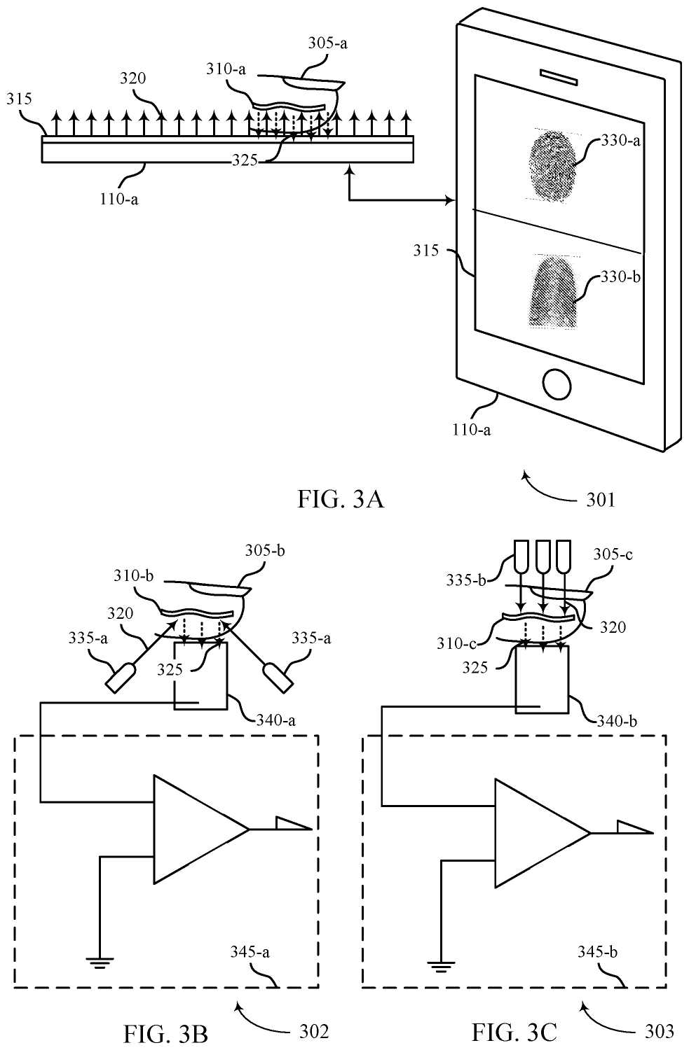

FIG. 3A illustrates an example of a sensing mode 301 that supports biometric fingerprint photoacoustic tomographic imaging in accordance with aspects of the present disclosure. In some examples, sensing mode 301 may implement aspects of system 100 or excitation scheme 200 and may be implemented by a device 110-a, which may be an example of a device 110 described with reference to FIGS. 1 and 2. Device 110-a may interact with a biological tissue, such as a finger 305-a containing one or more blood vessels 310 (e.g., including blood vessel 310-a), to perform electromagnetic excitation of the biological tissue and produce a biometric image.

In some examples, device 110-a may be a personal electronic device, such as a smartphone, and may include a display 315 (e.g., an LED or OLED display). Display 315 may be configured to produce pulses of one or more electromagnetic waves 320, which may interact with finger 305-a and/or blood vessels 310. As described with reference to FIG. 2, electromagnetic waves 320 may enter finger 305-a (e.g., penetrate finger 305-a to a certain depth), interact with finger tissue and/or blood vessels 310, and ultrasonic waves 325 may propagate from the finger tissue and/or blood vessels 310. In some cases, device 110-a may be configured with an ultrasonic sensor (e.g., a PMUT array, a CMUT array, etc.) to measure ultrasonic waves 325. Device 110-a may measure ultrasonic waves 325 and may use the measurement to form and output (e.g., display) a biometric image 330, such as fingerprint image 330-a or blood vessel image 330-b. Device 110-a may also output a liveness level associated with finger 305-a or blood vessels 310 within finger 305-a. In some examples, measurements of ultrasonic waves 325 may be tomographically vascular imaged to produce blood vessel image 330-b. Additionally or alternatively, measurements of ultrasonic waves 325 may be used an ensonification source for fingerprint imaging (e.g., may produce a flat image or may produce slices of fingerprint ridges). In some cases, tomographically imaging a fingerprint may include capturing multiple layers of ridge structure and may thus capture a fingerprint image that is not affected by worn fingerprint ridges and/or skin damage.

In some cases, display 315 may illuminate finger 305-a with different wavelengths of electromagnetic waves 320 (e.g., different colors of visible light), where each wavelength may excite different internal biological objects within finger 305-a (e.g., blood vessels 310, finger tissue, etc.). In one example, display 315 may produce electromagnetic waves 320 with a wavelength of 532 nanometers (nm) (e.g., green light). In some cases, this wavelength may excite hemoglobin in blood vessels 310 to generate ultrasonic waves 325 that emanate from the blood vessels 310 and form a tomographic biometric image. In another example, display 315 may produce electromagnetic waves 320 with a wavelength of 850 nm (e.g., near infrared illumination) to produce ultrasonic waves 325 at deeper finger tissue and form a tomographic biometric image. In another example, display 315 may produce electromagnetic waves 320 with red wavelengths, blue wavelengths, green wavelengths, or a combination thereof to produce ultrasonic waves 325 at varying tissue depths and output a resulting tomographic biometric image.

FIGS. 3B and 3C illustrate examples of sensing modes 302 and 303 that support biometric fingerprint photoacoustic tomographic imaging in accordance with aspects of the present disclosure. In some examples, sensing modes 302 and 303 may implement aspects of system 100 or excitation scheme 200 and may be implemented by one or more electromagnetic wave sources 335, an ultrasound receiver 340, and a circuit 345. In some cases, aspects of sensing modes 302 and 303 may be implemented by a device 110, which may an example of a device 110 described with reference to FIGS. 1 and 2. The device 110 may interact with a biological tissue, such as a finger 305-b or 305-c containing one or more blood vessels 310 (e.g., blood vessel 310-b or 310-c), to perform electromagnetic excitation of the biological tissue and produce a biometric image.

In some examples, the device 110 may represent a personal electronic device or may form part of a personal device, such as a smartphone. Additionally or alternatively, the device 110 may represent part of a security device, a medical imaging device, or the like. In one example, one or more electromagnetic wave sources 335 may be configured to produce pulses of one or more electromagnetic waves 320, which may interact with finger 305-b or 305-c and/or corresponding blood vessels 310. In some cases, electromagnetic wave sources 335 may be examples of LEDs or other light sources. Additionally or alternatively, electromagnetic wave sources 335 may emit infrared waves, radio waves, or the like. As described with reference to FIG. 2, electromagnetic waves 320 may enter finger 305-b or 305-c (e.g., penetrate finger 305-b or 305-c to a certain depth), interact with finger tissue and/or blood vessels 310, and ultrasonic waves 325 may propagate from the finger tissue and/or blood vessels 310. In one example (e.g., sensing mode 302), electromagnetic wave sources 335-a may be positioned in a first mode, such as a reflected illumination mode, such that electromagnetic waves 320 may enter finger 305-b from a same side on which an ultrasound receiver 340-a is positioned. In a separate example (e.g., sensing mode 303), electromagnetic wave sources 335-b may be positioned in a direct illumination mode, such that electromagnetic waves 320 may enter finger 305-c from a different side (e.g., opposite side) than a side on which an ultrasound receiver 340-b is positioned.

The ultrasound receiver 340 (e.g., a PMUT array, a CMUT array, etc.) may be configured to measure ultrasonic waves 325. In some cases, ultrasound receiver 340 may interact with a circuit 345-a or 345-b to backscatter image a number of plane slices through the tissue of finger 305-b or 305-c and/or blood vessels 310 to generate a tomographic representation (e.g., image) of a fingerprint and/or a vascular system. For example, ultrasound receiver 340 and circuit 345-a or 345-b may perform synthetic aperture processing after collecting amplitude and phase data at a number of points of interest.

Additionally or alternatively, ultrasound receiver 340 and circuit 345-a or 345-b may backscatter reconstruct an image of the number of plane slices and apply a point spread function to the backscattered reconstructed image to generate a biometric image (e.g., 3D fingerprint or blood vessel image) of finger 305-b or 305-c. In some cases, backscatter imaging and synthetic aperture processing may take place entirely within ultrasound receiver 340. In some cases, backscatter imaging and synthetic aperture processing may take place at one or more other components of the device 110. The output of this process may include a tomographic representation of one or more characteristics of finger 305-b or 305-c, such as an image of the fingerprint (e.g., slices of the ridge structure) associated with finger 305-b or 305-c or a 3D blood vessel geometry associated with finger 305-b or 305-c.

In some cases, electromagnetic wave sources 335 may be configured (e.g., by the device 110, by a processor, etc.) to illuminate finger 305-b or 305-c with different wavelengths of electromagnetic waves 320 (e.g., different colors of visible light), where each wavelength may excite different internal biological objects within finger 305-b or 305-c (e.g., blood vessels 310, finger tissue, etc.). In one example, electromagnetic wave sources 335 may produce electromagnetic waves 320 with a wavelength of 532 nm (e.g., green light). In some cases, this wavelength may excite hemoglobin in blood vessels 310 to generate ultrasonic waves 325 that emanate from the blood vessels 310 and generate a tomographic biometric image. In another example, electromagnetic wave sources 335 may produce electromagnetic waves 320 with a wavelength of 850 nm (e.g., near infrared illumination) to produce ultrasonic waves 325 at deeper finger tissue and generate a tomographic biometric image. In another example, electromagnetic wave sources 335 may produce electromagnetic waves 320 with red wavelengths, blue wavelengths, green wavelengths, or a combination thereof to produce ultrasonic waves 325 at varying tissue depths and output a tomographic biometric image.

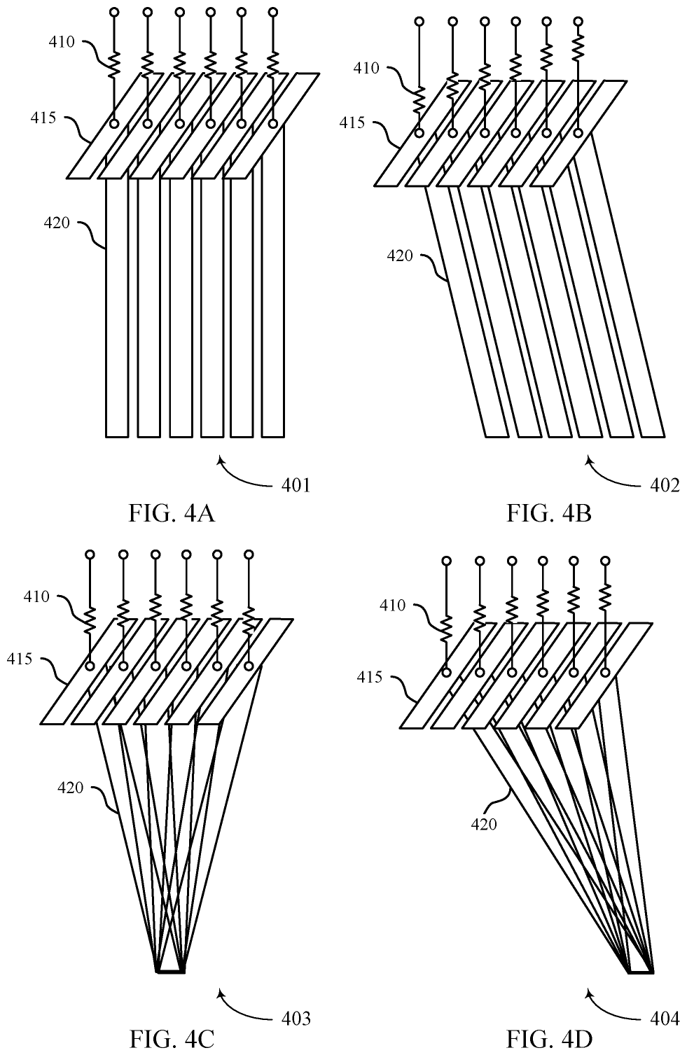

FIGS. 4A through 4D illustrate examples of beamforming techniques 401, 402, 403, and 404 that support biometric fingerprint photoacoustic tomographic imaging in accordance with aspects of the present disclosure. In some examples, beamforming techniques 401, 402, 403, and 404 may implement aspects of system 100, excitation scheme 200, or sensing modes 301, 302, or 303. In some cases, beamforming techniques 401, 402, 403, and 404 may be implemented by a device 110, which may an example of a device 110 described with reference to FIGS. 1 through 3. In some examples, beamforming techniques 401, 402, 403, and 404 may be implemented within a component of the device 110, such as an ultrasound receiver, which may be an example of an ultrasound receiver described with reference to FIGS. 3B and 3C. The device 110 may interact with a biological tissue to perform electromagnetic excitation of the biological tissue and produce a biometric image. In some cases, the device 110 may further use synthetic aperture processing or beamforming (e.g., beamforming techniques 401, 402, 403, or 404) to generate a tomographic representation (e.g., image) of a biological tissue (e.g., fingerprint, vascular system, etc.).

Beamforming techniques 401, 402, 403, or 404 may be an example of signal processing techniques used in sensor arrays for directional signal transmission or reception to achieve spatial selectivity. For example, the device 110, or components of the device 110 (e.g., a synthetic aperture or beamforming component), may combine elements in a phased array (e.g., ultrasonic sensor array) such that signals at some angles experience constructive interference and signals at other angles experience destructive interference. In some cases, a beamforming element may control phase and relative amplitude of signals received and/or transmitted by the array to generate the constructive and/or destructive interference in a signal wave front. Combining the controlled signals from the array elements may result in a spatially-selective signal (e.g., ultrasound measurement or image) that may focus on one or more spatial areas (e.g., of biological tissue) for imaging or other signal processing. For example, the spatially-selective signal may be received based on a propagation direction of electromagnetic waves within a biological tissue or based on an area of biological tissue being imaged. In some cases, beamforming techniques may result in improved element signal transmission and/or reception compared with omnidirectional transmission and/or reception, which may be referred to as element directivity. In some examples, when receiving signals, information from different sensors (e.g., different parts of a receiver array) may be combined such that patterns of radiation (e.g., received waves) may be observed.

Accordingly, different beamforming techniques or synthetic aperture techniques (e.g., different constructive and destructive interference patterns) may result in improved signal reception from different spatial areas or locations. For example, the device 110 may receive measurement signals 410 (e.g., including phase and amplitude) from an array (e.g., an ultrasonic receiver array), where each signal 410 may be provided by one element of the array. The signals 410 may be processed within the device (e.g., using a synthetic aperture 415) by controlling phase and relative amplitude of the signals 410 to combine the signal and manage constructive and destructive interference of the combined signals 410. In some cases, the array may process the signals by activating one or more pixel rows and/or columns of the array based on a pattern to receive (e.g., collect) the phases and amplitudes of the received signals in a certain pattern. The process of controlling phase and relative amplitude of the signals 410 may result in one or more synthetic signals 420, which may be focused on a given spatial area or location from which the signals 410 originated. For example, the process may orient received signals such that the directionality of the array is based on a propagation direction of electromagnetic waves within a biological tissue. This process may be repeated at multiple plane slices of a biological tissue to construct a 3D image.

In one example, beamforming technique 401 may be used to focus the synthetic signals 420 in a line, which may be referred to as line-focused beamforming. Beamforming technique 402 may be used to focus synthetic signals 420 in a line directed to a given area, which may be referred to as line-focused beamforming with steering. Beamforming technique 403 may be used to focus the synthetic signals 420 at a point, which may be referred to as point-focused beamforming. Additionally, beamforming technique 404 may be used to focus synthetic signals 420 at a point directed to a given location, which may be referred to as point-focused beamforming with steering. Images of planed within a biological tissue may be formed using one or more of beamforming techniques 401, 402, 403, and/or 404, and this process may be repeated at various points in a plane and at various planes to construct a 3D tomographic image of a biological tissue (e.g., finger, blood vessel, eye, etc.)

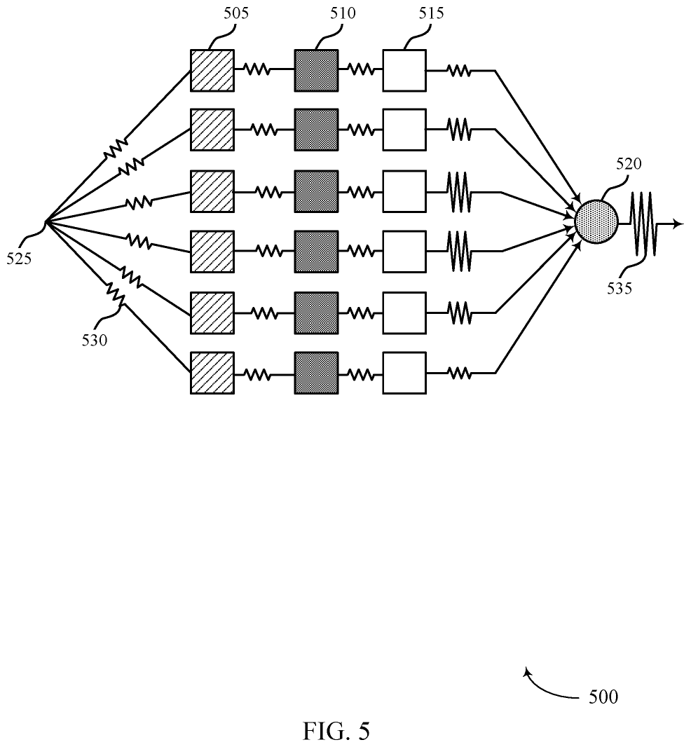

FIG. 5 illustrates an example of a beamforming processing scheme 500 that supports biometric fingerprint photoacoustic tomographic imaging in accordance with aspects of the present disclosure. In some examples, beamforming processing scheme 500 may implement aspects of system 100, excitation scheme 200, sensing modes 301, 302, or 303, or beamforming techniques 401, 402, 403, or 404. In some cases, beamforming processing scheme 500 may be implemented by a device 110, which may an example of a device 110 described with reference to FIGS. 1 through 4. In some examples, beamforming processing scheme 500 may be implemented within a component of the device 110, such as an ultrasound receiver, which may be an example of an ultrasound receiver described with reference to FIGS. 3B and 3C. The device 110 may interact with a biological tissue to perform electromagnetic excitation of the biological tissue and produce a biometric image. In some cases, the device 110 may further use synthetic aperture processing or beamforming (e.g., beamforming processing scheme 500) to generate a tomographic representation (e.g., image) of a biological tissue (e.g., fingerprint, vascular system, etc.).

Beamforming processing scheme 500 may include array elements 505 (e.g., of an ultrasonic receiver array), delay lines 510, weighting factor components 515, and an adder 520. In some cases, the device 110 may use these components to process data from a focal point 525 and produce a synthetic signal 535 corresponding to a signal measurement (e.g., image, ultrasound data, etc.) from the focal point 525. As discussed with reference to FIGS. 4A through 4D, a beamforming process may control phase and relative amplitude of signals 530 received by array elements 505 to generate constructive and/or destructive interference in a signal wave front and focus received signals 530 in one or more directions or locations (e.g., in a propagation direction of emitted electromagnetic waves). In some cases, the array may generate interference by activating one or more pixel rows and/or columns of the array based on a pattern to receive (e.g., collect) the phases and amplitudes of the received signals 530 in a certain pattern. Combining the phase-and-amplitude-controlled signals may result in a spatially-selective or synthetic signal 535 (e.g., ultrasound measurement or image) that may focus on one or more spatial areas (e.g., of biological tissue) for imaging or other signal processing. In some cases, the focal point 525 may represent a point that may be imaged using synthetic aperture processing or beamforming (e.g., where each array element 505 may be synthetically focused on the focal point 525).

In one example, a biological tissue may be electromagnetically excited and may produce ultrasonic waves, as discussed with reference to FIGS. 1 through 3. An ultrasound receiver or other component of the device 110 may determine to process signals 530 using a beamforming processing scheme 500 (e.g., synthetic aperture) such that any signals 530 received from the ultrasonic waves may be combined to generate a synthetic signal 535 focusing on one point or one area of the biological tissue (e.g., focal point 525).

In some cases, array elements 505 (e.g., elements in a PMUT or CMUT array, etc.) may interact with the signals 530 (e.g., ultrasonic waves) and may produce electronic signals from the interaction. These electronic signals may be passed through delay lines 510, which may modify the electronic signals to account for any relative time delays or time differences that exist between the focal point 525 and each array element 505. In some cases, delay lines 510 may process the electronic signals using the signal phase to modify the electronic signals. The electronic signals may also be processed using weighting factor components 515, which may weight each electronic signal to account for the relative importance of each array element 505 in receiving signals 530 from the focal point 525. In some cases, weighting factor components 515 may process the electronic signals using the relative signal amplitude to modify the electronic signals. The weighted electronic signals may be passed through adder 520 to combine the electronic signals associated with each array element 505. Adder 520 may therefore output a synthetic signal 535 that approximates a signal focused on one point or area of the biological tissue.

In some cases, the processes of beamforming processing scheme 500 may be repeated for multiple points or areas within the biological tissue to gather data from all points or areas of interest (e.g., as determined by the device 110 or a user of the device 110). In some cases, the resulting synthetic signals 535 may be used to generate an image or other measurement associated with the biological tissue, such as a fingerprint, blood vessel image, or liveness level.

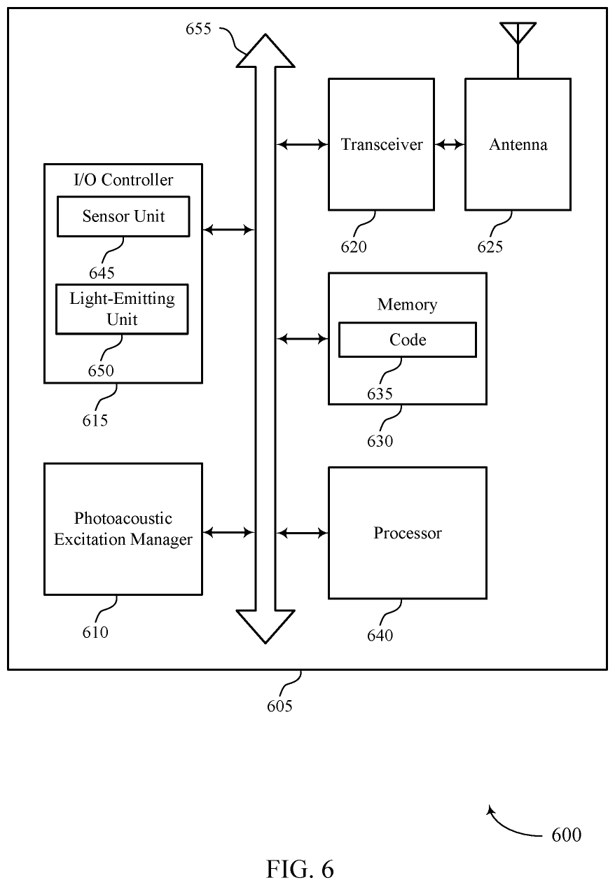

FIG. 6 shows a diagram of a system 600 including a device 605 that supports biometric fingerprint photoacoustic tomographic imaging in accordance with aspects of the present disclosure. The device 605 may be an example of or include the components of device 110 as described herein. The device 605 may include an ultrasonic imaging sensor configured to determine ridges and valleys of a fingerprint. The ultrasonic imaging sensor may include a pixel array which may include a multiple PMUTs or CMUTs. The device 605 may include components for bi-directional data communications including components for transmitting and receiving communications, including a tomographic imaging manager 610, an I/O controller 615, memory 630, and a processor 640. These components may be in electronic communication via one or more buses (e.g., bus 655).

The tomographic imaging manager 610 may generate one or more pulses of electromagnetic radiation waves having one or more characteristics, emit the one or more pulses of electromagnetic radiation waves to generate one or more ultrasonic signals associated with one or more biological tissues of a finger, sense the one or more generated ultrasonic signals at a set of plane slices of the one or more biological tissues using an ultrasonic receiver array based on emitting the one or more pulses of electromagnetic radiation waves, perform fingerprint information reconstruction using the one or more ultrasonic signals to generate fingerprint information at one or more plane slices of the set of plane slices of the one or more biological tissues, generate a fingerprint image including ridges and valleys associated with the finger based on performing the fingerprint information reconstruction, and output a representation of the fingerprint image.

In some examples, tomographic imaging manager 610 may generate, via a light emitting source of the device, the one or more pulses of electromagnetic radiation waves, where the light emitting source includes an LED or an OLED display interface. In some examples, tomographic imaging manager 610 may perform a backscatter reconstruction at different plane slices of the set of plane slices of the one or more biological tissues to generate a backscattered reconstructed fingerprint image of the different plane slices of the set of plane slices, where generating the fingerprint image includes applying a point spread function to the backscattered reconstructed fingerprint image to generate the fingerprint image.

In some examples, tomographic imaging manager 610 may sense, via a PMUT of the device, the one or more generated ultrasonic waves, where the fingerprint image includes a tomographic fingerprint image or a tomographic vascular image based on sensing the one or more generated ultrasonic waves over the set of plane slices of the one or more biological tissues. In some examples, the tomographic imaging manager 610 may control a directionality of the array of pixel elements of the PMUT based on a propagation direction of the one or more pulses of electromagnetic radiation waves. In some examples, the tomographic imaging manager 610 may collect phases and amplitudes of the one or more generated ultrasonic waves at different plane slices of the set of plane slices of the one or more biological tissues based on the controlling, where generating the fingerprint image is further based on combining one or more generated ultrasonic waves at same plane slices of the set of plane slices based on the phases and the amplitudes of the one or more generated ultrasonic waves.

In some examples, the tomographic imaging manager 610 may activate one or more of pixel rows or pixel columns of the array of pixel elements based on a pattern. In some examples, the tomographic imaging manager 610 may convert the one or more generated ultrasonic waves to one or more pixels based on one or more pixel elements of the array of pixel elements, where generating the fingerprint image is further based on the converting. In some examples, the tomographic imaging manager 610 may synchronize an activation time of a light emitting source of the device and an exposure time of one or more of a camera of the device to sense the one or more pulses of electromagnetic radiation waves or the ultrasonic receiver array to sense the one or more generated ultrasonic waves at the set of plane slices of the one or more biological tissues, where generating the fingerprint image includes performing, based on the synchronizing, range gated imaging at the one or more plane slices of the set of plane slices of the one or more biological tissues to generate a multi-dimensional fingerprint image.

In some examples, the tomographic imaging manager 610 may select one or more characteristics of the one or more pulses of electromagnetic radiation waves based on a target plane slice of the set of plane slices associated with the one or more biological tissues of the finger, where emitting the one or more pulses of electromagnetic radiation waves includes emitting the one or more pulses of electromagnetic radiation waves having the one or more characteristics based at least in part on the selecting, the one or more characteristics comprising one or more of the intensity of the one or more pulses of electromagnetic radiation waves, the propagation direction of the one or more pulses of electromagnetic radiation waves, or the wavelength of the one or more pulses of electromagnetic radiation waves.

In some examples, the tomographic imaging manager 610 may determine a profile of the one or more biological tissues of the finger based on sensing the one or more generated ultrasonic waves at the set of plane slices of the one or more biological tissues using the ultrasonic receiver array. In some examples, the tomographic imaging manager 610 may determine a liveliness level of the one or more biological tissues of the finger based on the profile, where outputting the representation of the fingerprint image includes outputting the liveliness level associated with the one or more biological tissues of the finger. In some examples, the tomographic imaging manager 610 may output, via an OLED display interface of the device, the representation of the fingerprint image.

In some cases, the wavelength is within a radio spectrum of an electromagnetic spectrum, a microwave spectrum of the electromagnetic spectrum, a near-infrared spectrum of the electromagnetic spectrum, an infrared spectrum of the electromagnetic spectrum, a visible spectrum of the electromagnetic spectrum, or an ultraviolet spectrum of the electromagnetic spectrum. In some cases, the profile includes a shape of a biological tissue of the one or more biological tissues of the finger or a size of the biological tissue of the one or more biological tissues of the finger, or both.

The tomographic imaging manager 610, or its sub-components, may be implemented in hardware, code (e.g., software or firmware) executed by a processor, or any combination thereof. If implemented in code executed by a processor, the functions of the tomographic imaging manager 610, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The tomographic imaging manager 610, or its sub-components, may be physically located at various positions, including being distributed such that portions of functions are implemented at different physical locations by one or more physical components. In some examples, the tomographic imaging manager 610, or its sub-components, may be a separate and distinct component in accordance with various aspects of the present disclosure. In some examples, the tomographic imaging manager 610, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS, ANDROID, MS-DOS, MS-WINDOWS, OS/2, UNIX, LINUX, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

In some examples, the I/O controller 615 may include a sensor unit 645 and a light-emitting unit 650. The sensor unit 645 may include one or more sensors (e.g., which may be referred to as an ultrasonic sensor, and electrode array, a scanner, etc.) to sense biometric information (e.g., to determine valley and ridges of a fingerprint). The sensor unit 645 may include a pixel array including one or more PMUTs or CMUTs and may be coordinated with the light-emitting unit 650. For example, the sensor unit 645 may receive one or more signals (e.g., signals generated using photoacoustic excitation) or imaging information indicative of traits (e.g., biometric traits) associated with a fingerprint (or other object). In response to the one or more signals, the processor 640 may image the fingerprint, perform an authentication analysis, etc. In some cases, the sensor unit 645 may be attached to or mounted on a frame of the device 605 near or under a cover surface of the device's display (e.g., an OLED display, a pOLED display, etc.).

The device 605 may also include electrical connections associated with the sensor unit 645 and the processor 640. In some examples, the tomographic imaging manager 610 may control various aspects of the sensor unit 645 (e.g., ultrasonic receiver timing and coordination with excitation waveforms, bias voltages for the ultrasonic receiver and pixel circuitry, pixel addressing, signal filtering and conversion, readout frame rates, and so forth). The processor 640 may send level select input signals through another bias driver to bias one or more electrodes and allow gating of acoustic signal detection by the sensor unit 645 (e.g., pixel circuitry). A demultiplexer may be used to turn on and off gate drivers that cause a particular row or column of the sensor unit 645 (e.g., sensor pixel circuits) to provide sensor output signals. Output signals from the pixels may be sent through a charge amplifier, a filter (e.g., an anti-aliasing filter), and a digitizer to the processor 640.

The light-emitting unit 650 may include one or more sources for producing electromagnetic wave pulses (e.g., which may be referred to as an electromagnetic wave source) to perform photoacoustic excitation and generate ultrasonic waves to determine valley and ridges of a fingerprint). The light-emitting unit 650 may be coordinated (e.g., coordinated timing) with the sensor unit 645 to detect ultrasonic waves and generate a fingerprint image. For example, the light-emitting unit 650 may produce one or more electromagnetic waves that may excite tissue within a finger and generate one or more ultrasonic waves or signals. In response to the one or more signals, the processor 640 may image the fingerprint, perform an authentication analysis, etc. In some cases, the light-emitting unit 650 may be attached to or mounted on a frame of the device 605 near or under a cover surface of the device's display (e.g., an OLED display, a pOLED display, etc.), within the device's display, or outside of the device.

The device 605 may also include electrical connections associated with the light-emitting unit 650 and the processor 640. In some examples, the tomographic imaging manager 610 may control various aspects of the light-emitting unit 650 (e.g., electromagnetic wave timing and wavelength, and so forth). For example, the processor 640 may send an excitation signal to a driver of the light-emitting unit 650 to cause the driver to produce electromagnetic waves or signals.

The memory 630 may include RAM and ROM. The memory 630 may store computer-readable, computer-executable code or software 635 including instructions that, when executed, cause the processor to perform various functions described herein. In some cases, the memory 630 may contain, among other things, a BIOS which may control basic hardware or software operation such as the interaction with peripheral components or devices.

The software 635 may include instructions to implement aspects of the present disclosure, including instructions to support biometric scanning. The software 635 may be stored in a non-transitory computer-readable medium such as system memory or other type of memory. In some cases, the software 635 may not be directly executable by the processor 640 but may cause a computer (e.g., when compiled and executed) to perform functions described herein.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks reducing background signals in imaging sensors, supporting ultrasonic biometric sensing).

The processor 640 may receive the one or more signals representative of a fingerprint, and may process such information as discussed herein (e.g., the processor 640 may image a fingerprint, perform authentication procedures, etc.). In some cases, the processor 640 and/or light-emitting unit 650 may introduce an applied voltage that may drive one or more electromagnetic wave sources of the light-emitting unit 650 to transmit one or more electromagnetic waves. The processor 640 may receive data from the sensor unit 645 that may include translating digitized data into image data of the fingerprint or format the data for further processing (e.g., such as for authentication procedures). In some other cases, the processor 640 and/or sensor unit 645 may apply bias voltages to one or more electrodes of the sensor unit 645 to receive a generated ultrasonic signal, such that the processor may output a representation of the fingerprint using an image processing technique.

As detailed above, the tomographic imaging manager 610 and/or one or more components of the tomographic imaging manager 610 may perform and/or be a means for performing, either alone or in combination with other components, one or more operations for supporting ultrasonic fingerprint scanning by means of photoacoustic excitation. For example, the tomographic imaging manager 610 may perform and/or be a means for generating one or more pulses of electromagnetic radiation waves having one or more characteristics. The tomographic imaging manager 610 may perform and/or be a means for emitting the one or more pulses of electromagnetic radiation waves to generate one or more ultrasonic signals associated with one or more biological tissues of a finger. In some examples, the sensor unit 645 either alone or in combination with the light-emitting unit 650 may perform and/or be means for generating one or more pulses of electromagnetic radiation waves having one or more characteristics.

The tomographic imaging manager 610 may perform and/or be a means for sensing the one or more generated ultrasonic signals at a set of plane slices of the one or more biological tissues using an ultrasonic receiver array based at least in part on emitting the one or more pulses of electromagnetic radiation waves. In some examples, the sensor unit 645 either alone or in combination with the light-emitting unit 650 may perform and/or be means for sensing the one or more generated ultrasonic signals at a set of plane slices of the one or more biological tissues using an ultrasonic receiver array based at least in part on emitting the one or more pulses of electromagnetic radiation waves.

The tomographic imaging manager 610 may perform and/or be a means for performing fingerprint information reconstruction using the one or more ultrasonic signals to generate fingerprint information at one or more plane slices of the set of plane slices of the one or more biological tissues. The tomographic imaging manager 610 may perform and/or be a means for generating a fingerprint image comprising ridges and valleys associated with the finger based at least in part on performing the fingerprint information reconstruction. The tomographic imaging manager 610 may perform and/or be a means for outputting a representation of the fingerprint image.

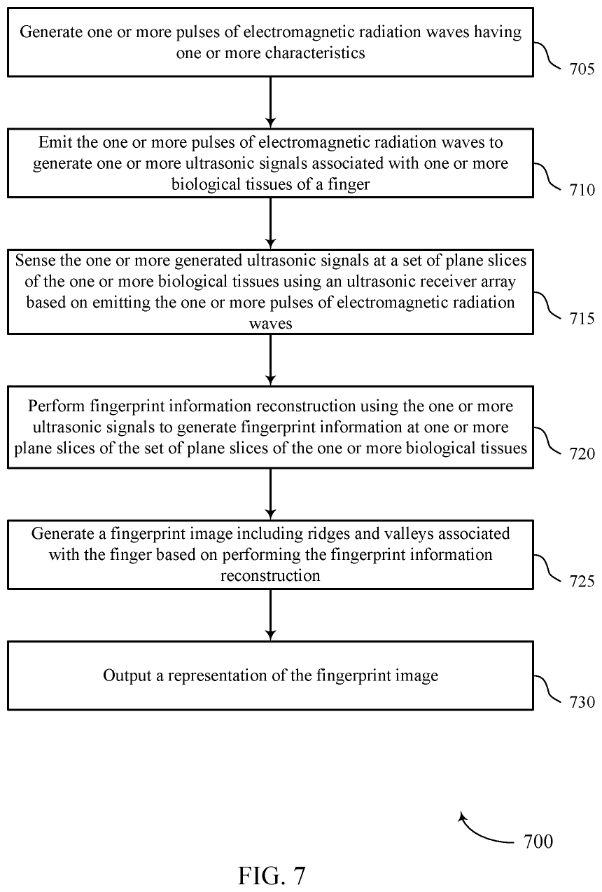

FIG. 7 shows a flowchart illustrating a method 700 that supports biometric fingerprint photoacoustic tomographic imaging in accordance with aspects of the present disclosure. The operations of method 700 may be implemented by a device or its components as described herein. For example, the operations of method 700 may be performed by a tomographic imaging manager as described with reference FIG. 6. In some examples, a device may execute a set of instructions to control the functional elements of the device to perform the functions described below. Additionally or alternatively, a device may perform aspects of the functions described below using special-purpose hardware.

At 705, the device may generate one or more pulses of electromagnetic radiation waves having one or more characteristics. The operations of 705 may be performed according to the methods described herein. In some examples, aspects of the operations of 705 may be performed by a tomographic imaging manager as described with reference FIG. 6.

At 710, the device may emit the one or more pulses of electromagnetic radiation waves to generate one or more ultrasonic signals associated with one or more biological tissues of a finger. The operations of 710 may be performed according to the methods described herein. In some examples, aspects of the operations of 710 may be performed by a tomographic imaging manager as described with reference FIG. 6.

At 715, the device may sense the one or more generated ultrasonic signals at a set of plane slices of the one or more biological tissues using an ultrasonic receiver array based on emitting the one or more pulses of electromagnetic radiation waves. The operations of 715 may be performed according to the methods described herein. In some examples, aspects of the operations of 715 may be performed by a tomographic imaging manager as described with reference FIG. 6.

At 720, the device may perform fingerprint information reconstruction using the one or more ultrasonic signals to generate fingerprint information at one or more plane slices of the set of plane slices of the one or more biological tissues. The operations of 720 may be performed according to the methods described herein. In some examples, aspects of the operations of 720 may be performed by a tomographic imaging manager as described with reference FIG. 6.

At 725, the device may generate a fingerprint image including ridges and valleys associated with the finger based on performing the fingerprint information reconstruction. The operations of 725 may be performed according to the methods described herein. In some examples, aspects of the operations of 725 may be performed by a tomographic imaging manager as described with reference FIG. 6.

At 730, the device may output a representation of the fingerprint image. The operations of 730 may be performed according to the methods described herein. In some examples, aspects of the operations of 730 may be performed by a tomographic imaging manager as described with reference FIG. 6.

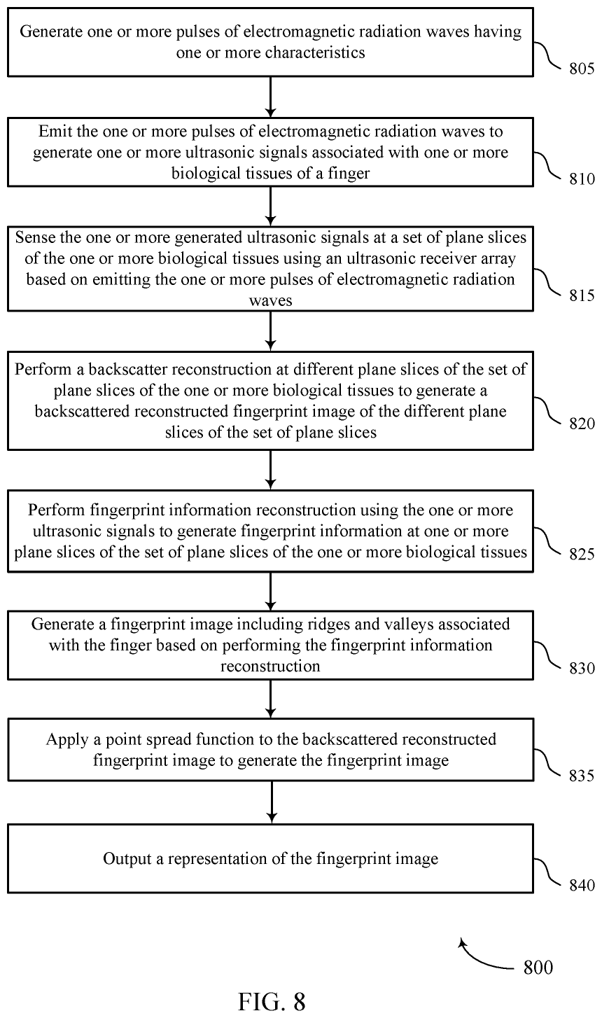

FIG. 8 shows a flowchart illustrating a method 800 that supports biometric fingerprint photoacoustic tomographic imaging in accordance with aspects of the present disclosure. The operations of method 800 may be implemented by a device or its components as described herein. For example, the operations of method 800 may be performed by a tomographic imaging manager as described with reference FIG. 6. In some examples, a device may execute a set of instructions to control the functional elements of the device to perform the functions described below. Additionally or alternatively, a device may perform aspects of the functions described below using special-purpose hardware.

At 805, the device may generate one or more pulses of electromagnetic radiation waves having one or more characteristics. The operations of 805 may be performed according to the methods described herein. In some examples, aspects of the operations of 805 may be performed by a tomographic imaging manager as described with reference FIG. 6.

At 810, the device may emit the one or more pulses of electromagnetic radiation waves to generate one or more ultrasonic signals associated with one or more biological tissues of a finger. The operations of 810 may be performed according to the methods described herein. In some examples, aspects of the operations of 810 may be performed by a tomographic imaging manager as described with reference FIG. 6.

At 815, the device may sense the one or more generated ultrasonic signals at a set of plane slices of the one or more biological tissues using an ultrasonic receiver array based on emitting the one or more pulses of electromagnetic radiation waves. The operations of 815 may be performed according to the methods described herein. In some examples, aspects of the operations of 815 may be performed by a tomographic imaging manager as described with reference FIG. 6.

At 820, the device may perform a backscatter reconstruction at different plane slices of the set of plane slices of the one or more biological tissues to generate a backscattered reconstructed fingerprint image of the different plane slices of the set of plane slices, where generating the fingerprint image includes applying a point spread function to the backscattered reconstructed fingerprint image to generate the fingerprint image. The operations of 820 may be performed according to the methods described herein. In some examples, aspects of the operations of 820 may be performed by a tomographic imaging manager as described with reference FIG. 6.

At 825, the device may perform fingerprint information reconstruction using the one or more ultrasonic signals to generate fingerprint information at one or more plane slices of the set of plane slices of the one or more biological tissues. The operations of 825 may be performed according to the methods described herein. In some examples, aspects of the operations of 825 may be performed by a tomographic imaging manager as described with reference FIG. 6.

At 830, the device may generate a fingerprint image including ridges and valleys associated with the finger based on performing the fingerprint information reconstruction. The operations of 830 may be performed according to the methods described herein. In some examples, aspects of the operations of 830 may be performed by a tomographic imaging manager as described with reference FIG. 6.

At 835, the device may apply a point spread function to the backscattered reconstructed fingerprint image to generate the fingerprint image. The operations of 835 may be performed according to the methods described herein. In some examples, aspects of the operations of 835 may be performed by a tomographic imaging manager as described with reference FIG. 6.

At 840, the device may output a representation of the fingerprint image. The operations of 840 may be performed according to the methods described herein. In some examples, aspects of the operations of 840 may be performed by a tomographic imaging manager as described with reference FIG. 6.

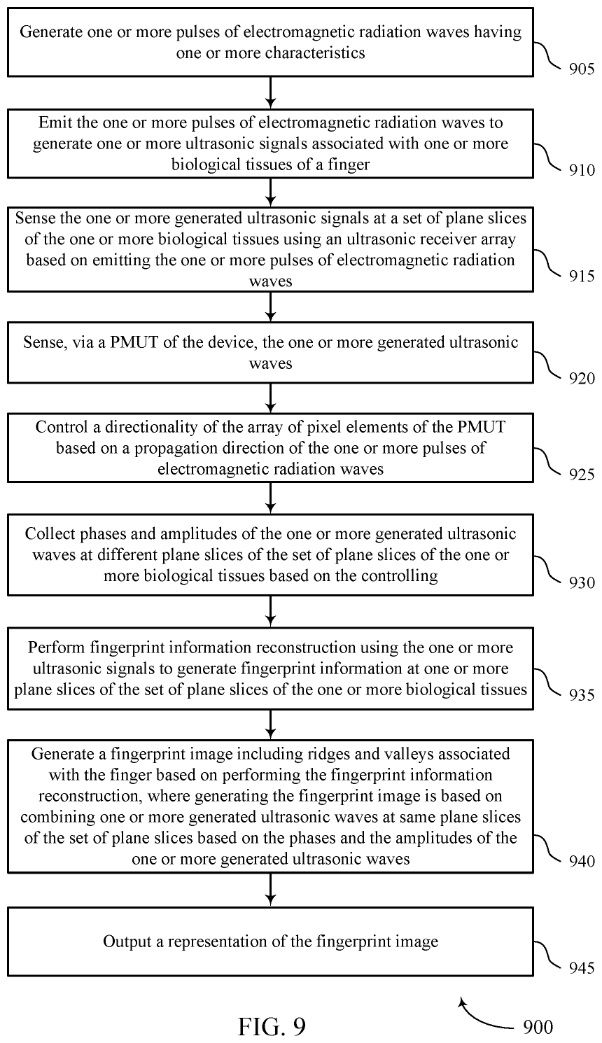

FIG. 9 shows a flowchart illustrating a method 900 that supports biometric fingerprint photoacoustic tomographic imaging in accordance with aspects of the present disclosure. The operations of method 900 may be implemented by a device or its components as described herein. For example, the operations of method 900 may be performed by a tomographic imaging manager as described with reference FIG. 6. In some examples, a device may execute a set of instructions to control the functional elements of the device to perform the functions described below. Additionally or alternatively, a device may perform aspects of the functions described below using special-purpose hardware.

At 905, the device may generate one or more pulses of electromagnetic radiation waves having one or more characteristics. The operations of 905 may be performed according to the methods described herein. In some examples, aspects of the operations of 905 may be performed by a tomographic imaging manager as described with reference FIG. 6.

At 910, the device may emit the one or more pulses of electromagnetic radiation waves to generate one or more ultrasonic signals associated with one or more biological tissues of a finger. The operations of 910 may be performed according to the methods described herein. In some examples, aspects of the operations of 910 may be performed by a tomographic imaging manager as described with reference FIG. 6.

At 915, the device may sense the one or more generated ultrasonic signals at a set of plane slices of the one or more biological tissues using an ultrasonic receiver array based on emitting the one or more pulses of electromagnetic radiation waves. The operations of 915 may be performed according to the methods described herein. In some examples, aspects of the operations of 915 may be performed by a tomographic imaging manager as described with reference FIG. 6.

At 920, the device may sense, via a PMUT of the device, the one or more generated ultrasonic waves. The operations of 920 may be performed according to the methods described herein. In some examples, aspects of the operations of 920 may be performed by a tomographic imaging manager as described with reference FIG. 6.

At 925, the device may control a directionality of the array of pixel elements of the PMUT based on a propagation direction of the one or more pulses of electromagnetic radiation waves. The operations of 925 may be performed according to the methods described herein. In some examples, aspects of the operations of 925 may be performed by a tomographic imaging manager as described with reference FIG. 6.

At 930, the device may collect phases and amplitudes of the one or more generated ultrasonic waves at different plane slices of the set of plane slices of the one or more biological tissues based on the controlling. The operations of 930 may be performed according to the methods described herein. In some examples, aspects of the operations of 930 may be performed by a tomographic imaging manager as described with reference FIG. 6.

At 935, the device may perform fingerprint information reconstruction using the one or more ultrasonic signals to generate fingerprint information at one or more plane slices of the set of plane slices of the one or more biological tissues. The operations of 935 may be performed according to the methods described herein. In some examples, aspects of the operations of 935 may be performed by a tomographic imaging manager as described with reference FIG. 6.

At 940, the device may generate a fingerprint image including ridges and valleys associated with the finger based on performing the fingerprint information reconstruction, where generating the fingerprint image is based on combining one or more generated ultrasonic waves at same plane slices of the set of plane slices based on the phases and the amplitudes of the one or more generated ultrasonic waves. The operations of 940 may be performed according to the methods described herein. In some examples, aspects of the operations of 940 may be performed by a tomographic imaging manager as described with reference FIG. 6.

At 945, the device may output a representation of the fingerprint image. The operations of 945 may be performed according to the methods described herein. In some examples, aspects of the operations of 945 may be performed by a tomographic imaging manager as described with reference FIG. 6.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” will not be construed as a reference to a closed set of conditions. For example, an exemplary step that is described as “based on condition A” may be based on both a condition A and a condition B without departing from the scope of the present disclosure. In other words, as used herein, the phrase “based on” will be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of biometric identification at a device, comprising:
generating one or more pulses of electromagnetic radiation waves having one or more characteristics;
emitting the one or more pulses of electromagnetic radiation waves to generate one or more ultrasonic signals associated with one or more biological tissues of a finger;
sensing the one or more generated ultrasonic signals at a set of plane slices of the one or more biological tissues using an ultrasonic receiver array based at least in part on emitting the one or more pulses of electromagnetic radiation waves;
performing fingerprint information reconstruction using the one or more ultrasonic signals to generate fingerprint information at one or more plane slices of the set of plane slices of the one or more biological tissues;
generating a fingerprint image comprising ridges and valleys associated with the finger based at least in part on performing the fingerprint information reconstruction; and
outputting a representation of the fingerprint image.

2. The method of claim 1, wherein generating the one or more pulses of electromagnetic radiation waves comprises:
generating, via a light emitting source of the device, the one or more pulses of electromagnetic radiation waves, wherein the light emitting source comprises a light emitting diode (LED) or an organic light emitting diode (OLED) display interface.

3. The method of claim 1, wherein performing the fingerprint information reconstruction comprises:
performing a backscatter reconstruction at different plane slices of the set of plane slices of the one or more biological tissues to generate a backscattered reconstructed fingerprint image of the different plane slices of the set of plane slices, wherein generating the fingerprint image comprises applying a point spread function to the backscattered reconstructed fingerprint image to generate the fingerprint image.

4. The method of claim 1, wherein sensing the one or more generated ultrasonic waves comprises:
sensing, via a piezoelectric micromachined ultrasonic transducer of the device, the one or more generated ultrasonic waves, wherein the fingerprint image comprises a tomographic fingerprint image or a tomographic vascular image based at least in part on sensing the one or more generated ultrasonic waves over the set of plane slices of the one or more biological tissues.

5. The method of claim 4, wherein the piezoelectric micromachined ultrasonic transducer of the device comprises an array of pixel elements, and wherein sensing the one or more generated ultrasonic waves comprises:
controlling a directionality of the array of pixel elements of the piezoelectric micromachined ultrasonic transducer based at least in part on a propagation direction of the one or more pulses of electromagnetic radiation waves; and
collecting phases and amplitudes of the one or more generated ultrasonic waves at different plane slices of the set of plane slices of the one or more biological tissues based at least in part on the controlling, wherein generating the fingerprint image is further based at least in part on combining one or more generated ultrasonic waves at same plane slices of the set of plane slices based at least in part on the phases and the amplitudes of the one or more generated ultrasonic waves.

6. The method of claim 5, wherein collecting the phases and the amplitudes of the one or more generated ultrasonic waves at different plane slices of the set of plane slices of the one or more biological tissues comprises:
activating one or more of pixel rows or pixel columns of the array of pixel elements based at least in part on a pattern.

7. The method of claim 4, wherein the piezoelectric micromachined ultrasonic transducer of the device comprises an array of pixel elements, and wherein sensing the one or more generated ultrasonic waves at the set of plane slices of the one or more biological tissues using the ultrasonic receiver array comprises:
converting the one or more generated ultrasonic waves to one or more pixels based at least in part on one or more pixel elements of the array of pixel elements, wherein generating the fingerprint image is further based at least in part on the converting.

8. The method of claim 1, further comprising:
synchronizing an activation time of a light emitting source of the device and an exposure time of one or more of:
a camera of the device to sense the one or more pulses of electromagnetic radiation waves, or
the ultrasonic receiver array to sense the one or more generated ultrasonic waves at the set of plane slices of the one or more biological tissues,
wherein generating the fingerprint image comprises:
performing, based at least in part on the synchronizing, range gated imaging at the one or more plane slices of the set of plane slices of the one or more biological tissues to generate a multi-dimensional fingerprint image.

9. The method of claim 1, wherein generating the one or more pulses of electromagnetic radiation waves comprises:
selecting one or more characteristics of the one or more pulses of electromagnetic radiation waves based at least in part on a target plane slice of the set of plane slices associated with the one or more biological tissues of the finger,
wherein emitting the one or more pulses of electromagnetic radiation waves comprises:
emitting the one or more pulses of electromagnetic radiation waves having the one or more characteristics based at least in part on the selecting, the one or more characteristics comprising one or more of the intensity of the one or more pulses of electromagnetic radiation waves, the propagation direction of the one or more pulses of electromagnetic radiation waves, or the wavelength of the one or more pulses of electromagnetic radiation waves.

10. The method of claim 9, wherein the wavelength is within a radio spectrum of an electromagnetic spectrum (EM) spectrum, a microwave spectrum of the EM spectrum, a near-infrared spectrum of the EM spectrum, an infrared spectrum of the EM spectrum, a visible spectrum of the EM spectrum, or an ultraviolet spectrum of the EM spectrum.

11. The method of claim 1, further comprising:
determining a profile of the one or more biological tissues of the finger based at least in part on sensing the one or more generated ultrasonic waves at the set of plane slices of the one or more biological tissues using the ultrasonic receiver array;
determining a liveliness level of the one or more biological tissues of the finger based at least in part on the profile,
wherein outputting the representation of the fingerprint image comprises outputting the liveliness level associated with the one or more biological tissues of the finger.

12. The method of claim 11, wherein the profile comprises a shape of a biological tissue of the one or more biological tissues of the finger or a size of the biological tissue of the one or more biological tissues of the finger, or both.

13. The method of claim 1, wherein outputting the representation of the fingerprint image comprises:
outputting, via an organic light emitting diode (OLED) display interface of the device, the representation of the fingerprint image.

14. An apparatus for biometric identification, comprising:
a processor,
memory coupled with the processor; and
instructions stored in the memory and executable by the processor to cause the apparatus to:
generate one or more pulses of electromagnetic radiation waves having one or more characteristics;
emit the one or more pulses of electromagnetic radiation waves to generate one or more ultrasonic signals associated with one or more biological tissues of a finger;
sense the one or more generated ultrasonic signals at a set of plane slices of the one or more biological tissues using an ultrasonic receiver array based at least in part on emitting the one or more pulses of electromagnetic radiation waves;
perform fingerprint information reconstruction using the one or more ultrasonic signals to generate fingerprint information at one or more plane slices of the set of plane slices of the one or more biological tissues;
generate a fingerprint image comprising ridges and valleys associated with the finger based at least in part on performing the fingerprint information reconstruction; and
output a representation of the fingerprint image.

15. The apparatus of claim 14, wherein the instructions to perform the fingerprint information reconstruction are executable by the processor to cause the apparatus to:
perform a backscatter reconstruction at different plane slices of the set of plane slices of the one or more biological tissues to generate a backscattered reconstructed fingerprint image of the different plane slices of the set of plane slices, wherein the instruction to generate the fingerprint image are executable by the processor to cause the apparatus to apply a point spread function to the backscattered reconstructed fingerprint image to generate the fingerprint image.

16. The apparatus of claim 14, wherein the instructions to sense the one or more generated ultrasonic waves are executable by the processor to cause the apparatus to:
sense, via a piezoelectric micromachined ultrasonic transducer of the apparatus, the one or more generated ultrasonic waves, wherein the fingerprint image comprises a tomographic fingerprint image or a tomographic vascular image based at least in part on sensing the one or more generated ultrasonic waves over the set of plane slices of the one or more biological tissues.

17. The apparatus of claim 16, wherein the piezoelectric micromachined ultrasonic transducer of the apparatus comprises an array of pixel elements, and wherein the instructions to sense the one or more generated ultrasonic waves are executable by the processor to cause the apparatus to:
control a directionality of the array of pixel elements of the piezoelectric micromachined ultrasonic transducer based at least in part on a propagation direction of the one or more pulses of electromagnetic radiation waves; and
collect phases and amplitudes of the one or more generated ultrasonic waves at different plane slices of the set of plane slices of the one or more biological tissues based at least in part on the controlling, wherein generating the fingerprint image is further based at least in part on combining one or more generated ultrasonic waves at same plane slices of the set of plane slices based at least in part on the phases and the amplitudes of the one or more generated ultrasonic waves.

18. The apparatus of claim 17, wherein the instructions to collect the phases and the amplitudes of the one or more generated ultrasonic waves at different plane slices of the set of plane slices of the one or more biological tissues are executable by the processor to cause the apparatus to:
activate one or more of pixel rows or pixel columns of the array of pixel elements based at least in part on a pattern.

19. The apparatus of claim 16, wherein the piezoelectric micromachined ultrasonic transducer of the apparatus comprises an array of pixel elements, and wherein the instructions to sense the one or more generated ultrasonic waves at the set of plane slices of the one or more biological tissues using the ultrasonic receiver array are executable by the processor to cause the apparatus to:
convert the one or more generated ultrasonic waves to one or more pixels based at least in part on one or more pixel elements of the array of pixel elements, wherein generating the fingerprint image is further based at least in part on the converting.

20. An apparatus for biometric identification, comprising:
means for generating one or more pulses of electromagnetic radiation waves having one or more characteristics;
means for emitting the one or more pulses of electromagnetic radiation waves to generate one or more ultrasonic signals associated with one or more biological tissues of a finger;
means for sensing the one or more generated ultrasonic signals at a set of plane slices of the one or more biological tissues using an ultrasonic receiver array based at least in part on emitting the one or more pulses of electromagnetic radiation waves;
means for performing fingerprint information reconstruction using the one or more ultrasonic signals to generate fingerprint information at one or more plane slices of the set of plane slices of the one or more biological tissues;
means for generating a fingerprint image comprising ridges and valleys associated with the finger based at least in part on performing the fingerprint information reconstruction; and
means for outputting a representation of the fingerprint image.
